(19) United States
(12) Patent Application Publication
(10) Pub. No.: US 2026/0188711 A1
(43) Pub. Date: Jul. 2, 2026

(54) COOLANT EXPANSION TANK FOR FUEL CELL STACK VEHICLE COOLING SYSTEM

(71) Applicant: Volvo Truck Corporation, GÖTEBORG (SE)

(72) Inventor: Rikard HULTHÉN, Stora Höga (SE)

(21) Appl. No.: 19/125,560

(22) PCT Filed: Nov. 29, 2022
(86) PCT No.: PCT/IB2022/061533

§ 371 Date: Apr. 29, 2025

(51) Int. Cl. H01M 8/04044; H01M 8/04007; H01M 8/04029

(52) U.S. Cl. CPC H01M 8/04044; H01M 8/04029; H01M 8/04067; H01M 2250/20

(57) ABSTRACT

A coolant expansion tank for a vehicle cooling system includes a cooling fluid port for receiving cooling fluid for at least one coolant chamber on a coolant side of the coolant expansion tank. The tank further includes a transfer channel between the at least one coolant chamber and a pressured air side of the coolant expansion tank. The tank further includes the pressurized air side separated from the coolant side by a wall having the transfer channel, the pressurized air side providing pressurized air to the one or more coolant chambers via the transfer channel. The tank further includes a gas separation inlet on the coolant side for receiving gas separated from cooling fluid by a separator, the gas contributing to air pressure on the cooling fluid in the coolant side, wherein the excess pressure is released from the pressurized air side to a feed air transfer pipe.

### TECHNICAL FIELD

The disclosure relates generally to vehicle cooling systems. In particular aspects, the disclosure relates to a coolant expansion tank for a vehicle cooling system, such as a fuel cell stack (FCS) vehicle. The disclosure can be applied in heavy-duty vehicles, such as trucks, buses, and construction equipment. Although the disclosure may be described with respect to a particular vehicle, the disclosure is not restricted to any particular vehicle.

### BACKGROUND

Fuel cell stack (FCS) vehicles are different compared with internal combustion engine (ICE) vehicles. The FCS vehicles require a strict control of coolant system pressure. Therefore, an active pressure system is used on FCS vehicles.

One drawback of active pressure control is that pressurized air is used to create the required pressure. Adding fresh air continuously will increase ageing of the coolant fluid. When coolant ages, its pH decreases, making it less efficient to prevent corrosion inside the coolant system.

In some conventional solutions, a rubber bellow or membrane is used. Pressurized air is on one side, and the coolant on the opposite side. The pressurized air acts on the membrane and pressure is created in the coolant system.

Drawbacks of a membrane are that hydrogen is continuously released to the coolant system through dissipation through separating walls. The hydrogen accumulates inside the coolant expansion tank. Over time, the membrane can degrade and has to be replaced.

### SUMMARY

According to a first aspect of the disclosure, a coolant expansion tank for a vehicle cooling system. The coolant expansion tank further includes a transfer channel between the at least one coolant chamber and a pressured air side. The pressurized air side is separated from the coolant side by a wall having a transfer channel, the pressurized air side providing pressurized air to the one or more coolant chambers via the transfer channel. The coolant expansion tank further includes a gas separation inlet on the coolant side for receiving gas separated from coolant fluid by a separator, the gas contributing to air pressure on the coolant in the coolant side, wherein the excess pressure is released from the pressurized air side to a feed air transfer pipe. The first aspect of the disclosure may seek to pressurize and degas the coolant system using the coolant expansion tank without fresh air contacting the coolant during operation. A technical benefit may include eliminating the need to use a membrane that degrades over time.

In some examples, the pressurized air side has a first volume and receives pressurized air from a pressure regulator via a feed air transfer pipe having a same volume as the first volume. A technical benefit may include pressurizing the cooling system without fresh air being added coming into contact with the coolant.

In some examples, a Teflon membrane between the pressurized air side and the feed air transfer pipe. A technical benefit may include letting air/hydrogen be released into the feed air transfer pipe while preventing water vapor from entering the pressurized air side.

In some examples, the transfer channel has a first opening proximate a bottom of the pressurized air side and a second opening proximate a top of the coolant side. A technical benefit may include allowing air and gas to flow between the pressurized air side and the coolant side without fresh air coming into contact with the coolant on the coolant side.

In some examples, the coolant expansion tank is in a vehicle cooling system for a hydrogen fuel cell stack vehicle cooling system.

According to a second aspect of the disclosure, a coolant system for a vehicle cooling system includes a cooling expansion tank that includes a cooling fluid port for receiving cooling fluid for one or more coolant chambers on a coolant side; a gas separation inlet on the coolant side for receiving gas separated from coolant fluid by a separator, the gas contributing to air pressure on the coolant in the coolant side; and a pressurized air side separated from the coolant side by a wall having a transfer channel. The coolant system further includes a separator for receiving coolant and separating gas from the coolant and providing the gas to the coolant expansion tank. The coolant system further includes a feed air transfer pipe for providing pressurized air from a pressure regulator, the feed air transfer pipe having a volume equal to the first volume to avoid injecting fresh air that will reach the coolant. The second aspect of the disclosure may seek to pressurize and degas the coolant system using the coolant expansion tank without fresh air contacting the coolant during operation. A technical benefit may include eliminating the need to use a membrane that degrades over time.

In some examples, the coolant system includes a filter membrane between the pressurized air side and the feed air transfer pipe. A technical benefit may include letting air/hydrogen be released into the feed air transfer pipe while preventing water vapor from entering the pressurized air side.

In some examples, the filter membrane comprises a water resistant material and a filter material. A technical benefit may include letting air/hydrogen be released into the feed air transfer pipe while preventing water vapor from entering the pressurized air side.

In some examples, the water resistant material comprises Teflon material. A technical benefit may include letting air/hydrogen be released into the feed air transfer pipe while preventing water vapor from entering the pressurized air side.

In some examples, the separator is located below the coolant expansion tank and above a cooling fluid pump. A technical benefit may include letting gravity to be used to operate the separator, thereby eliminating the need for a pump to separate the gas from coolant.

In some embodiments, the separator is a swirl pot that includes a round interior wall, wherein the cooling fluid is directed toward the round interior wall such that inertia of the cooling fluid causes the cooling fluid to move around the round interior wall in a vortex to press the cooling fluid against the round interior wall, wherein the pressure of the cooling fluid against the round interior wall causes the gas to move toward a center of the degassing chamber. A technical benefit may include letting gravity to be used to operate the separator, thereby eliminating the need for a pump to separate the gas from coolant where the gas in the center of the degassing chamber moves out of the swirling pot to the coolant in the coolant expansion tank.

In some embodiments, as the gas contributes to air pressure on the coolant in the coolant side, extra pressure is released from the pressurized air side resulting in the air pressure on the coolant stabilizing as air from the coolant side flows through the transfer channel to the pressurized air side. A technical benefit may include the transfer channel allowing air/gas to move towards the pressurized air side and be released to the feed air transfer pipe via the pressure regulator.

In some embodiments, the coolant system further includes a hydrogen fuel cell, a first radiator, a cooling fluid line for carrying fluid between the hydrogen fuel cell and the first radiator, and a pump configured to pump coolant fluid from the hydrogen fuel cell to the first radiator; a cooling fluid line from an output of the separator to the hydrogen fuel cell, wherein the cooling fluid line is angled downward to prevent circulation of coolant through the coolant expansion tank.

In some embodiments, the coolant system further includes a second radiator, the plurality of cooling fluid lines further carrying the cooling fluid between the hydrogen fuel cell and the second radiator.

In some embodiments, the separator is located vertically below the second radiator. A technical benefit may include letting gravity to be used to operate the separator, thereby eliminating the need for a pump to separate the gas from coolant where the gas in the center of the degassing chamber moves out of the swirling pot to the coolant in the coolant expansion tank.

According to a third aspect of the disclosure, a method of degassing and controlling pressure of coolant fluid in a vehicle cooling system includes receiving pressurized air at a pressurized air side of a coolant expansion tank separated by at least one coolant chamber on a coolant side by a wall having a transfer channel, the pressurized air received from a pressure regulator via a feed air transfer pipe. The method further includes providing pressurized air through the transfer channel to the at least one coolant chamber to pressurize coolant fluid in the at least one coolant chamber to a set pressure. The method further includes receiving gas separated from coolant fluid by a separator, the gas providing extra air pressure on the coolant side. The method further includes releasing the extra air pressure by releasing air from the pressurized air side via a regulator release valve, causing air to flow from the coolant side via the transfer channel to the pressurized air side, thereby removing the extra air pressure on the coolant side. The third aspect of the disclosure may seek to pressurize and degas the coolant system using the coolant expansion tank without fresh air contacting the coolant during operation. A technical benefit may include eliminating the need to use a membrane that degrades over time.

In some examples, the method further includes responsive to coolant fluid increasing temperature, releasing air to handle expansion of the coolant fluid due to the increasing temperature by releasing air from the pressurized air side via a regulator release valve, causing air to flow from the coolant side via the transfer channel to the pressurized air side, thereby allowing the coolant fluid to expand without increasing pressure. A technical benefit may include eliminating the need to use a membrane that degrades over time.

In some examples, the method further includes responsive to coolant fluid decreasing temperature, injecting air from the feed air transfer pipe into the pressurized air side to cause pressurized air to move through the transfer channel to keep pressure to the set pressure on the coolant side, whereby any fresh air only occupies the feed air transfer pipe where it does not oxidize any coolant. A technical benefit may include fresh air not contacting coolant, thereby having no increased aging from fresh air contacting coolant.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 illustrates a diagram of a cooling system for a Fuel Cell Stack (FCS) vehicle including a degassing and pressure equalization system, according to some embodiments;

FIG. 2 illustrates a degassing and pressure equalization system for a cooling system, according to some embodiments;

FIGS. 3A-3C illustrates a cutaway view of the coolant expansion tank and gas separator of FIG. 2, according to some embodiments;

FIGS. 4-6 are flowcharts of operations for operating a degassing system for a cooling system, according to some embodiments; and.

FIG. 5 is another view of FIG. 3, according to another example.

### DETAILED DESCRIPTION

Aspects set forth below represent the necessary information to enable those skilled in the art to practice the disclosure.

Drawbacks of a membrane in a coolant expansion tank are that hydrogen is continuously released to the coolant system through dissipation through separating walls. The hydrogen accumulates inside the coolant expansion tank.

According to various aspects no water vapor and no or minimal fresh air is mixed with the air inside the expansion tank. Air velocity inside a transfer pipe is kept low enough to avoid mixing of air, and as the air is being compressed, there will be no exchange between the fresh air inside the pipe and the tank. The concepts has the benefit of not having coolant exchange between expansion tank and the rest of the coolant system. Thus, potentially oxidized coolant will not mix with the fresh coolant inside the coolant system.

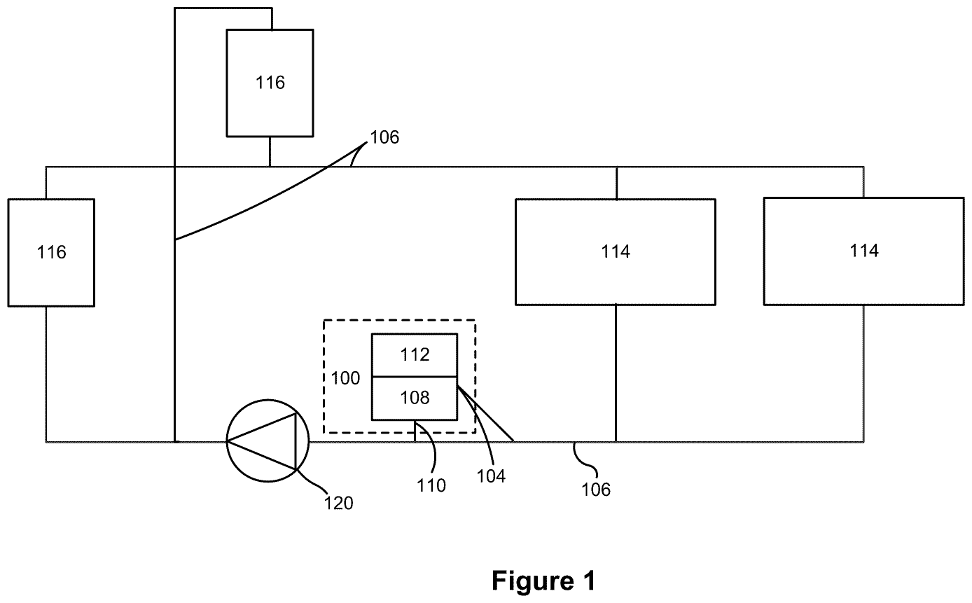

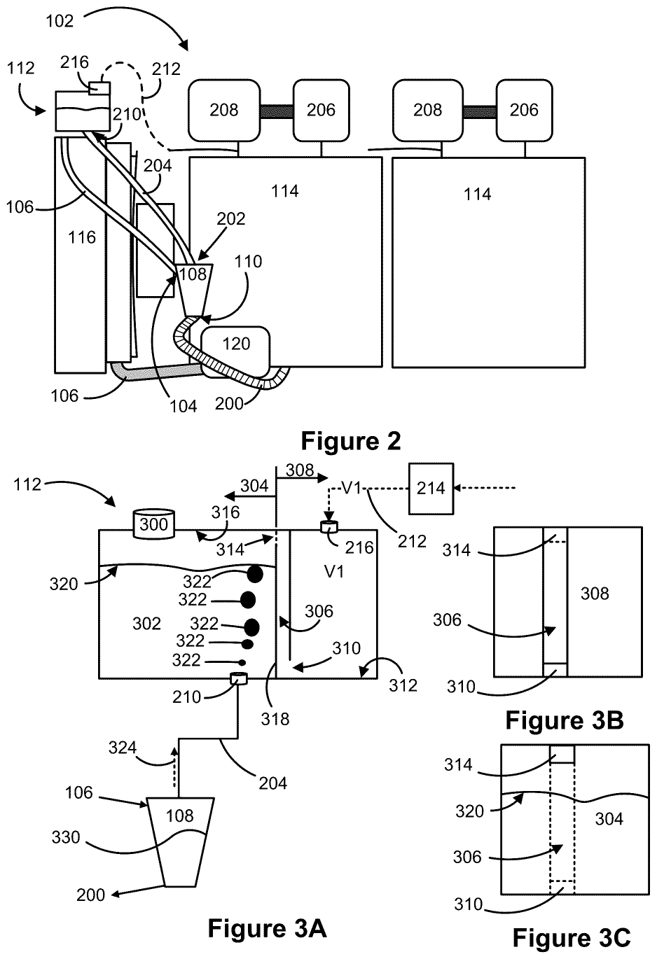

In this regard, FIG. 1 illustrates a diagram of degassing system 100 for a cooling system 102, according to some embodiments. In this example, the cooling system 102 is a hydrogen fuel cell cooling system for a Fuel Cell Stack (FCS) vehicle, but it should be understood that embodiments described herein may be applicable to many different types of cooling systems. The cooling system 102 includes a plurality of cooling fluid lines 106 for transporting cooling fluid to and from various components of the cooling system 102, such as Hydrogen Fuel Cells (HFCs) 114, radiators 116, 118, etc. The degassing system 100 includes a cooling fluid inlet 104 for receiving cooling fluid from a cooling fluid line 106 of a vehicle cooling system. In this example, the cooling fluid is pressurized using a cooling fluid pump 120, but it should be understood that the cooling fluid may be pressurized in a number of different ways, as desired. The cooling fluid enters a separator 108 through the cooling fluid inlet 104 from coolant line 106. As will be described in greater detail with respect to FIGS. 2 and 3 below, the cooling fluid is degassed, i.e., gas is removed from the cooling fluid, by movement of the cooling fluid within the separator 108, which causes the gas to be separated from the cooling fluid. The degassed cooling fluid is returned to the cooling fluid line 106 via a cooling fluid outlet 110 and fill line 200 and the removed gas is vented to the coolant expansion tank 112 via a gas outlet 202 and gas separator line 204 (by way of example, as shown in FIGS. 2 and 3 below).

Referring now to FIGS. 2 and 3A-3C, the HFCs 114 further includes compressors 206 and turbines 208. The pump 120 pumps hot coolant to radiator 116 (and 118, not shown) via coolant line 210. The coolant expansion tank 112 has a cooling fluid port 300 for providing cooling fluid for at least one coolant chamber 302 on a coolant side 304 of the coolant expansion tank 112. A transfer channel 306 having a first opening 310 proximate a bottom 312 of the pressurized air side 308 and a second opening 314 proximate a top 316 of the coolant side 314.

The pressurized air side 308 is separated from the coolant side 304 by a wall 318, the pressurized air side 308 providing pressurized air to the one or more coolant chambers 302 via the transfer channel 306. The second opening 314 on the wall 318 is the only opening of the wall 318. In other words, air and gas from the at least one coolant chamber can only get to the pressurized air side 308 via the transfer channel 306. In an example, the second opening 314 does not traverse the entire wall. In some cases, there may be a transfer channel for each of the at least one coolant chamber when coolant chambers are completely isolated from each other. In other cases, when there are multiple coolant chambers there may be a partial wall to separate the cooling fluid while the air in the multiple coolant chambers is not separated. In FIGS. 3A and 3B, line 320 represents the top of the cooling fluid in the at least one coolant chamber.

A gas separation inlet 210 on the coolant side 304 receives gas 322 separated from cooling fluid by the separator 108, the gas 322 contributing to air pressure on the cooling fluid in the coolant side, wherein the excess pressure is released from the pressurized air side 308 to a feed air transfer pipe 212.

In some aspects, the pressurized air side 308 has a first volume V1 (i.e., length of the pressurized air side 308 X width of the pressurized air side 308 X height of the pressurized air side 308 and receives pressurized air from a pressure regulator 214 via the feed air transfer pipe 212 having a same volume (V1) as the first volume.

In some aspects, a filter membrane 216 is between the pressurized air side 308 and the feed air transfer pipe 212. In some aspects, the filter membrane is a water resistant material and a filter material. In some of these aspects, the water resistant material is Teflon material. In other aspects, the filter membrane 216 is the Teflon material.

The separator 108 in some aspects is located below the coolant expansion tank 112 and above the cooling fluid pump 120.

In one example, the separator 108 is a swirl pot. The swirl pot has a round interior wall 330 such that inertia of the cooling fluid causes the cooling fluid to move around the round interior wall in a vortex to press the cooling fluid against the round interior wall 330, wherein the pressure of the cooling fluid against the round interior wall 330 causes the gas to move toward a center of the degassing chamber. The cooling fluid enters the separator 108 near the top of the swirl pot and swirls downward as more cooling fluid enters the separator 108 and flows out to the cooling fluid line 106 and on to the hydrogen fuel cell 114 via a cooling fluid outlet 110 and fill line 200 and the removed gas 322 is vented to the coolant expansion tank 112 via a gas outlet 202 and gas separator line 204. As the gas 322 contributes to air pressure on the coolant in the coolant side, extra pressure is released from the pressurized air side resulting in the air pressure on the coolant stabilizing as air from the coolant side flows through the transfer channel to the pressurized air side. In one aspect, the cooling fluid line 200 is angled downward to prevent circulation of cooling fluid through the coolant expansion tank 112.

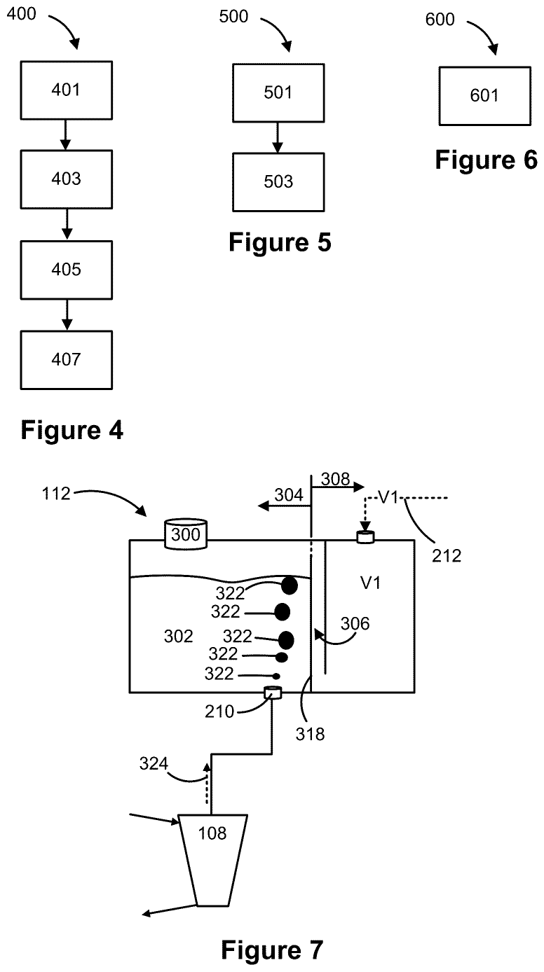

FIG. 4 is a flowchart of operations 400 for operating a degassing system for a cooling system, according to some aspects. The operations 400 include receiving pressurized air at a pressurized air side 308 of a coolant expansion tank 112 separated by at least one coolant chamber 302 on a coolant side 304 by a wall 318 having a transfer channel 306, the pressurized air received from a pressure regulator 216 via a feed air transfer pipe 212 (Block 401).

The operations 400 further include providing pressurized air through the transfer channel 306 to the at least one coolant chamber 302 to pressurize cooling fluid in the at least one coolant chamber 302 to a set pressure (Block 403).

The operations 400 further include receiving gas 322 separated from cooling fluid by a separator 108, the gas 322 providing extra air pressure on the coolant side 304 (Block 405). In this example, the separator 108 is located vertically below at least one radiator of the cooling system. For example, the separator 108 can be located vertically below the second radiator 118.

The operations 400 further include releasing the extra air pressure by releasing air from the pressurized air side 308 via the feed air transfer pipe 212, causing air to flow from the coolant side 304 via the transfer channel 306 to the pressurized air side 308, thereby removing the extra air pressure on the coolant side 304 (Block 407).

FIG. 5 is a flowchart of further operations 500 for operating the degassing system for a cooling system, according to some further aspects. The operations 500 include responsive to cooling fluid increasing temperature, releasing air to handle expansion of the cooling fluid due to the increasing temperature by releasing air from the pressurized air side 308 via the feed air transfer pipe 212, causing air to flow from the coolant side 302 via the transfer channel 306 to the pressurized air side 308, thereby allowing the cooling fluid to expand without increasing pressure (Block 501).

The operations 500 further include responsive to cooling fluid decreasing temperature, injecting air from the feed air transfer pipe 212 into the pressurized air side 308 to cause pressurized air to move through the transfer channel 306 to keep pressure to the set pressure on the coolant side 304, whereby fresh air only occupies the feed air transfer pipe 212 where it does not oxidize any cooling fluid (Block 503).

FIG. 6 is a flowchart of further operations 600 for operating the degassing system for a cooling system, according to some additional aspects. The operations 600 include providing cooling fluid having gas 322 within the cooling fluid to the separator 108, the separator 108 comprising a swirl pot having a round interior wall 330, wherein providing the cooling fluid comprises directing the cooling fluid having gas 322 toward the round interior wall 330 such that inertia of the cooling fluid having gas 322 causes the cooling fluid to move around the round interior wall 330 in a vortex to press the cooling fluid against the round interior wall 330, wherein the pressure of the cooling fluid against the round interior wall 330 causes the gas 322 to move toward a center of the separator (108) and be vented out a top of the separator (108) to the coolant side (304) (Block 601).

FIG. 7 is another view of FIG. 3A, according to another example. FIG. 7 illustrates a coolant expansion tank 112 for a vehicle cooling system. The coolant expansion tank 112 includes a cooling fluid port 300 for receiving cooling fluid for at least one coolant chamber 302 on a coolant side 304 of the coolant expansion tank 112. The coolant expansion tank 112 further includes a transfer channel 306 between the at least one coolant chamber 302 and a pressured air side 308 of the coolant expansion tank 112.

The pressurized air side 304 is separated from the coolant side 304 by a wall 318 having the transfer channel 306, the pressurized air side 308 providing pressurized air to the one or more coolant chambers 302 via the transfer channel 306. The coolant expansion tank 112 further includes the gas separation inlet 210 on the coolant side 304 for receiving gas 322 separated from cooling fluid by a separator 108, the gas contributing to air pressure on the cooling fluid in the coolant side 304, wherein the excess pressure is released from the pressurized air side 308 to a feed air transfer pipe 214.

There is no rubber bellow or membrane in the coolant expansion tank 112. The advantage this provides is that hydrogen can be released in an exhaust pipe and not accumulated inside the cooling system. There is also no need for any electromagnetic device to release hydrogen.

The coolant expansion tank 112 can be inside the top tank of the radiator or as a standalone bottle. No labyrinths or rubber bellows are necessary for operation. A rubber water release device that opens at max pressure only with a small area that has no practical effect on airflow through turbine can be used.

The feed air transfer pipe 212 with a defined area/length ratio avoids injection of fresh air to the coolant expansion tank 112.

The use of the filter membrane (Teflon and filter) and a tuned feed air transfer pipe between a fuel cell and the coolant expansion tank with a specific area/length ratio can result in no water vapor, and none or minimal fresh air is mixed with the air inside the expansion tank. Air velocity inside the feed air transfer pipe is kept low enough to avoid mixing of air, and as the air is being compressed, there will be no exchange between the fresh air inside the feed air transfer pipe and the coolant expansion tank.

The concepts described herein have the benefit of not having coolant exchange between the coolant expansion tank and the rest of the coolant system. Thus, potentially oxidized coolant will not mix with the fresh coolant inside the coolant system.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A coolant expansion tank for a vehicle cooling system, the coolant expansion tank comprising:
a cooling fluid port for receiving cooling fluid for at least one coolant chamber on a coolant side of the coolant expansion tank;
a transfer channel between the at least one coolant chamber and a pressured air side of the coolant expansion tank;
the pressurized air side separated from the coolant side by a wall having the transfer channel, the pressurized air side providing pressurized air to the one or more coolant chambers via the transfer channel; and
a gas separation inlet on the coolant side for receiving gas separated from cooling fluid by a separator, the gas contributing to air pressure on the cooling fluid in the coolant side, wherein the excess pressure is released from the pressurized air side to a feed air transfer pipe.

2. The coolant expansion tank according to claim 1, wherein the pressurized air side has a first volume and receives pressurized air from a pressure regulator via the feed air transfer pipe having a same volume as the first volume.

3. The coolant expansion tank according to claim 1, further comprising:
a Teflon membrane between the pressurized air side and the feed air transfer pipe.

4. The coolant expansion tank according to claim 1, wherein the transfer channel has a first opening proximate a bottom of the pressurized air side and a second opening proximate a top of the coolant side.

5. The coolant expansion tank according to claim 1, wherein the vehicle cooling system comprises a hydrogen fuel cell stack vehicle cooling system.

6. A coolant system for a vehicle cooling system, the coolant system comprising:
a coolant expansion tank comprising:
a cooling fluid port for receiving cooling fluid for one or more coolant chambers on a coolant side of the coolant expansion tank;
a gas separation inlet on the coolant side for receiving gas separated from cooling fluid by a separator, the gas contributing to air pressure on the cooling fluid in the coolant side;
a pressurized air side separated from the coolant side by a wall having a transfer channel, the pressurized air side having a first volume,
a separator for receiving cooling fluid and separating gas from the cooling fluid and providing the gas to the coolant expansion tank; and
a feed air transfer pipe for providing pressurized air from a pressure regulator, the feed air transfer pipe having a volume equal to the first volume to avoid injecting fresh air that will reach the cooling fluid.

7. The coolant system of claim 6, further comprising a filter membrane between the pressurized air side and the feed air transfer pipe.

8. The coolant system of claim 7, wherein the filter membrane comprises a water resistant material and a filter material.

9. The coolant system of claim 8, wherein the water resistant material comprises Teflon material.

10. The coolant system of claim 6, wherein the separator is located below the coolant expansion tank and above a cooling fluid pump.

11. The coolant system of claim 6, wherein the separator comprises a swirl pot comprising:
a round interior wall, wherein the cooling fluid is directed toward the round interior wall such that inertia of the cooling fluid causes the cooling fluid to move around the round interior wall in a vortex to press the cooling fluid against the round interior wall,
wherein the pressure of the cooling fluid against the round interior wall causes the gas to move toward a center of the degassing chamber.

12. The coolant system of claim 6, wherein as the gas contributes to air pressure on the cooling fluid in the coolant side, extra pressure is released from the pressurized air side resulting in the air pressure on the cooling fluid stabilizing as air from the coolant side flows through the transfer channel to the pressurized air side.

13. The coolant system of claim 6, wherein the vehicle cooling system comprises a hydrogen fuel cell cooling system.

14. The coolant system of claim 13, further comprising:
a hydrogen fuel cell;
a first radiator;
a plurality of cooling fluid lines for carrying fluid between the hydrogen fuel cell and the first radiator;
a pump configured to pump cooling fluid from the hydrogen fuel cell to the first radiator; and
a cooling fluid line from a cooling fluid outlet of the separator to the hydrogen fuel cell, wherein the cooling fluid line is angled downward to prevent circulation of cooling fluid through the coolant expansion tank.

15. The cooling system of claim 14, further comprising a second radiator, the plurality of cooling fluid lines further carrying the cooling fluid between the hydrogen fuel cell and the second radiator.

16. The cooling system of claim 15, wherein the separator is located vertically below the second radiator.

17. A method of degassing and controlling pressure of coolant fluid in a vehicle cooling system, the method comprising:
receiving pressurized air at a pressurized air side of a coolant expansion tank separated by at least one coolant chamber (on a coolant side by a wall having a transfer channel, the pressurized air received from a pressure regulator via a feed air transfer pipe;
providing pressurized air through the transfer channel to the at least one coolant chamber to pressurize cooling fluid in the at least one coolant chamber to a set pressure;
receiving gas separated from cooling fluid by a separator, the gas providing extra air pressure on the coolant side; and
releasing the extra air pressure by releasing air from the pressurized air side via the feed air transfer pipe, causing air to flow from the coolant side via the transfer channel to the pressurized air side, thereby removing the extra air pressure on the coolant side.

18. The method of claim 17, further comprising:
responsive to cooling fluid increasing temperature, releasing air to handle expansion of the cooling fluid due to the increasing temperature by releasing air from the pressurized air side via the feed air transfer pipe, causing air to flow from the coolant side via the transfer channel to the pressurized air side, thereby allowing the cooling fluid to expand without increasing pressure.

19. The method of claim 17, further comprising:
responsive to cooling fluid decreasing temperature, injecting air from the feed air transfer pipe into the pressurized air side to cause pressurized air to move through the transfer channel to keep pressure to the set pressure on the coolant side, whereby fresh air only occupies the feed air transfer pipe where it does not oxidize any cooling fluid.

20. The method of claim 16, wherein receiving gas separated from cooling fluid by a separator comprises:
providing cooling fluid having gas within the cooling fluid to the separator, the separator comprising a swirl pot having a round interior wall, wherein providing the cooling fluid comprises directing the cooling fluid having gas toward the round interior wall such that inertia of the cooling fluid having gas causes the cooling fluid to move around the round interior wall in a vortex to press the cooling fluid against the round interior wall,
wherein the pressure of the cooling fluid against the round interior wall causes the gas to move toward a center of the separator and be vented out a top of the separator to the coolant side.
